(19) United States
(12) Patent Application Publication
(10) Pub. No.: US 2020/0273076 A1
(43) Pub. Date: Aug. 27, 2020

(54) SYSTEMS AND METHODS FOR PROCESSING USER-GENERATED DATA ITEMS

(71) Applicant: Avaya Inc., Santa Clara, CA (US)

(72) Inventor: Navin Daga, Silapathar (IN)

(21) Appl. No.: 16/282,714

(22) Filed: Feb. 22, 2019

(51) Int. Cl. G06Q 30/02; H04L 12/58

(52) U.S. Cl. CPC G06Q 30/0282; H04L 51/16; H04L 51/046

(57) ABSTRACT

Systems and methods for processing user-generated data items comprising: selecting a first user-generated data item comprising a first content; reviewing a plurality of related user-generated data items each containing a second content, wherein one or more portions of the second content of each related user-generated data item relate to one or more portions of the first content of the first user-generated data item; selecting based on the first and second content, one or more of the related user-generated data items; and automatically providing the one or more related user-generated data items with the first user-generated data item.

### BACKGROUND

The present disclosure relates generally to processing of user-generated data items, and, more particularly, to providing a context for user-generated data items that are indicative of authenticity.

Businesses that sell goods and services online often provide websites that allow users to rate and/or review their products and services. Providers of digital publications and other digital content, including news outlets, technical journals, blog sites, and the like, also typically allow users to provide ratings and/or commentary on stories, articles, videos, postings, etc. Other users frequently consider this user-generated content and may be influenced by positive or negative ratings or reviews in making purchasing decisions, determining whether to visit a restaurant or other business, forming opinions about current events, etc. As a result, some businesses may employ paid contributors to provide positive feedback on their products and services, which may produce artificially high ratings/reviews that may not be reflective of the true sentiment of unbiased users. Likewise, competitors may be motivated to provide negative feedback, which may result in artificially low ratings/reviews for a competing business.

Many websites include policies that attempt to curb fraudulent or biased reviews, such as allowing only verified purchasers to leave feedback, but these policies are often relatively easy to avoid. In addition, some websites provide the option to leave a comment on a user rating/review, such as a rebuttal or a confirmation of one or more points in the user review. However, this process is typically arbitrary and relies on other users with the requisite knowledge becoming aware of the user review. Thus, many websites still contain fraudulent or biased user-generated content, and readers typically lack a mechanism to quickly and easily assess the authenticity and truthfulness of this user-generated content.

### BRIEF SUMMARY

One aspect of the present disclosure relates to a method comprising: selecting, by a processor, a first user-generated data item comprising a first content; reviewing, by the processor, a plurality of related user-generated data items each containing a second content, wherein one or more portions of the second content of each related user-generated data item relate to one or more portions of the first content of the first user-generated data item; selecting, by the processor, based on the first and second content, one or more of the related user-generated data items; and automatically providing, by the processor, the one or more related user-generated data items with the first user-generated data item.

Another aspect of the present disclosure relates to a system comprising: a memory device, storing executable instructions; a processor in communication with the memory device, wherein the processor when executing the executable instructions: selects a first user-generated data item comprising a first content; reviews a plurality of related user-generated data items each containing a second content, wherein one or more portions of the second content of each related user-generated data item relate to one or more portions of the first content of the first user-generated data item; selects, based on the first and second content, one or more of the related user-generated data items; and automatically provides the one or more related user-generated data items with the first user-generated data item.

### BRIEF DESCRIPTION OF THE DRAWINGS

So the manner in which the above recited features of the present disclosure may be understood in detail, a more particular description of embodiments of the present disclosure, briefly summarized above, may be had by reference to embodiments, which are illustrated in the appended drawings. It is to be noted, however, the appended drawings illustrate only typical embodiments encompassed within the scope of the present disclosure, and, therefore, are not to be considered limiting, for the present disclosure may admit to other equally effective embodiments, wherein:

FIG. 1 illustrates a system in accordance with principles of the present disclosure;

FIG. 2 illustrates aspects of an application server in accordance with principles of the present disclosure;

FIGS. 3A-3E and 4-6 are representations of webpages with one or more user-generated data items in accordance with the present disclosure; and

FIGS. 7A-7F are flowcharts of exemplary methods for processing user-generated data items in accordance with the present disclosure.

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description. Further, the examples disclosed are for illustrative purposes only and should not be construed as limiting of the scope of embodiments of the present disclosure.

The term “a” or “an” entity refers to one or more of that entity. As such, the terms “a” (or “an”), “one or more,” and “at least one” may be used interchangeably herein. It is also to be noted that the terms “comprising,” “including,” and “having” may be used interchangeably.

The term “automatic” and variations thereof, as used herein, refers to any process or operation done without material human input when the process or operation is performed. However, a process or operation may be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage and/or transmission medium that participates in storing and/or providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer may read. A digital file attachment to email or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

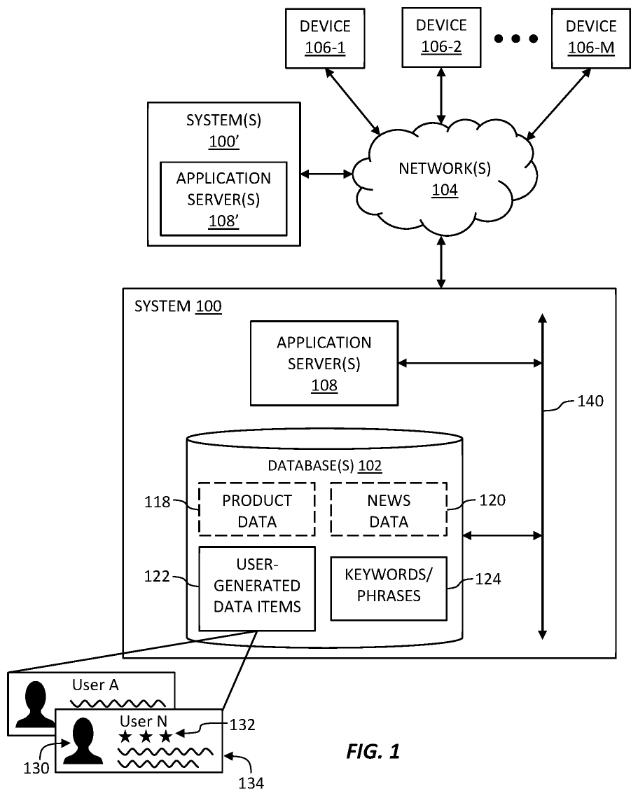

FIG. 1 shows an exemplary system 100 for selecting a first user-generated data item, reviewing and selecting one or more related user-generated data items, and providing, e.g., causing or driving the display, of the one or more related user-generated data items along with the first user-generated data item on a device associated with a user. The user-generated data items may comprise, for example, user reviews, ratings, and/or other user commentary related to various products, services, etc. As described herein in more detail, inclusion of the one or more related user-generated data items provides a reader with a context for the first user-generated data item so that the reader may assess the authenticity and/or truthfulness of the first user-generated data item.

The system 100 may comprise one or more application servers 108, which may store one or more applications or other programs, as described herein, and may be in communication with one or more databases 102. Some or all of the components of the system 100 may be interconnected by an internal network 140 such as a local area network (LAN) or wide area network (WAN). One or more of the components of the system 100 may also be connected via one or more optional communications links (not labeled) to one or more other components of the system 100. The system 100 may communicate with one or more user devices 106-1 to 106-M, where M is an integer, M≥1 (referred to herein collectively as user devices 106) via a communications network 104. Each user device 106 may be associated with a user and may comprise, for example, a smartphone, a Personal Digital Assistant (PDA), a laptop computer, a desktop computer, or any other type of device that is capable of connecting to the network 104 and communicating with the system 100. The network 104 may comprise a LAN, a WAN, the Internet, or any other known communications medium or mode or collection of communications media and/or modes that connect the user devices 106 to the system 100.

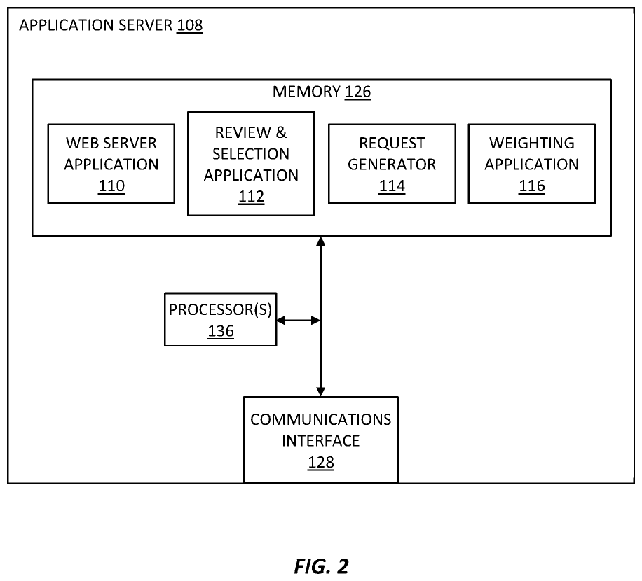

The system 100 may be associated with, or controlled by, an entity that provides web content in response to user requests received from the user devices 106. As shown in FIG. 2, the application server 108 may comprise one or more processors 136 coupled to a memory 126 that stores one or more of a web server application 110, a review and selection application 112, a request generator 114, and a weighting application 116. The application server 108 may communicate, via a communications interface 128, with one or more elements in the system 100, e.g., via the internal network 140. Although several functions are depicted in FIG. 2 as residing on the application server 108, it should be appreciated that one or more of the functions may reside on one or more separate servers (not shown).

In some examples, the system 100 may be associated with a merchant that sells one or more goods or services online, and the application server(s) 108 may provide online shopping services to the user devices 106 over the network 104 in a known manner. For instance, with reference to FIGS. 1, 2, and 3A, the web server application 110 may access product data 118 stored in the database(s) 102 to generate one or more webpages 300 in response to a user request received from one of the user devices 106, e.g., when the user associated with the user device 106 visits a website generated by the system 100 and clicks on a link for “Product Z.” The web server application 110 causes the webpage(s) 300 to be displayed on the user device 106. The webpage(s) 300 may provide, for example, information 302 regarding products and/or services, pricing, availability, and other information commonly provided to prospective online purchasers and may also be used to complete purchases. In other examples, the system 100 may be associated with an online news outlet, journal publisher, or other provider of digital content. For instance, with reference to FIGS. 1, 2, and 4, the web server application 110 may access news data 120 stored in the database(s) 102 to generate one or more webpages 400 that may provide information, such as a news article or editorial 402, a video, and the like in response to a user request received from one of the user devices 106. In further examples, as shown in FIG. 1, the system 100 may be in communication with, e.g., via the network 104, one or more other systems 100′. The other system(s) 100′ may be substantially similar to the system 100 and may each comprise one or more application servers 108′ and one or more databases (not shown), in which a web server application (not shown) generates one or more webpages, as described herein.

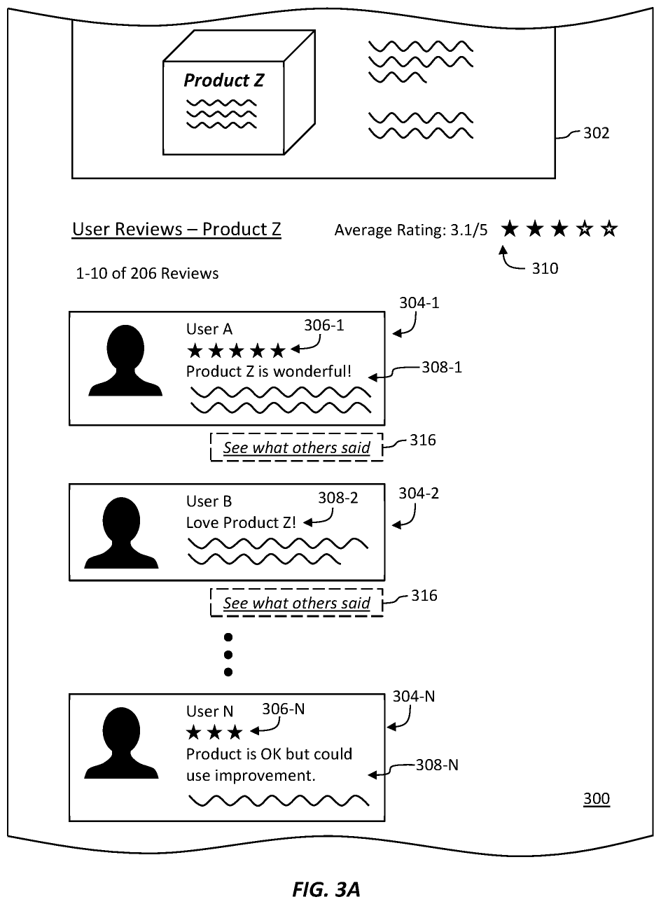

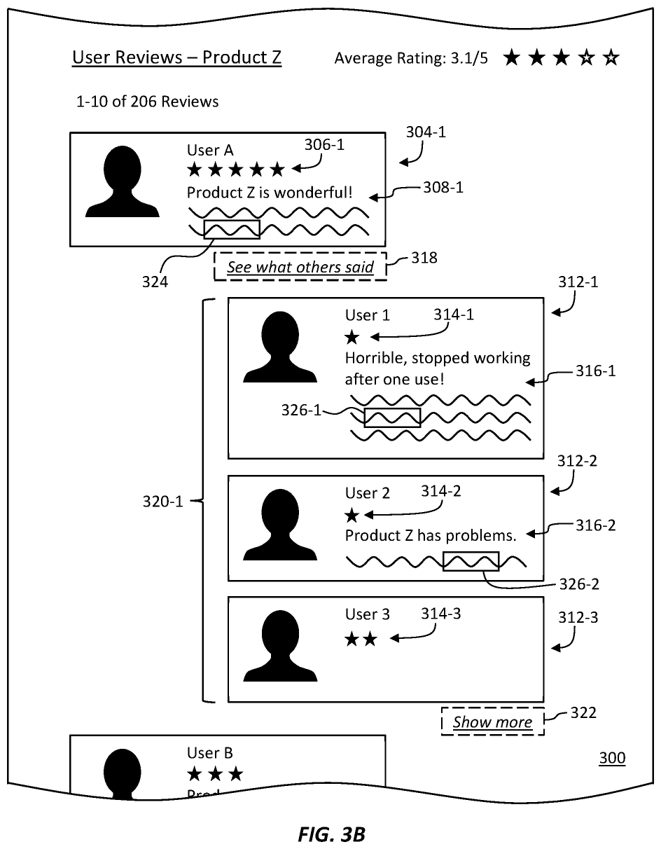

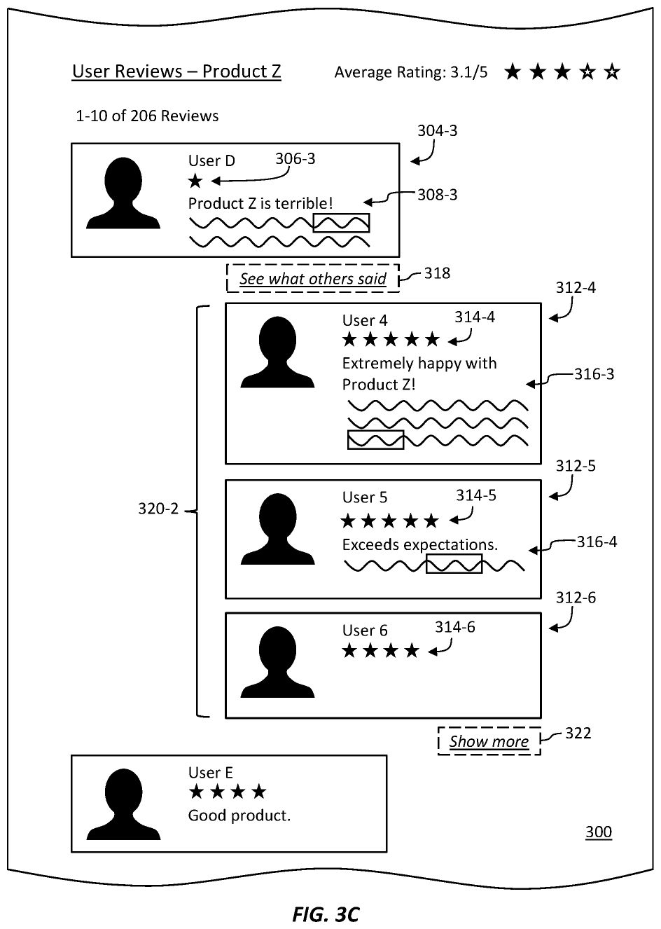

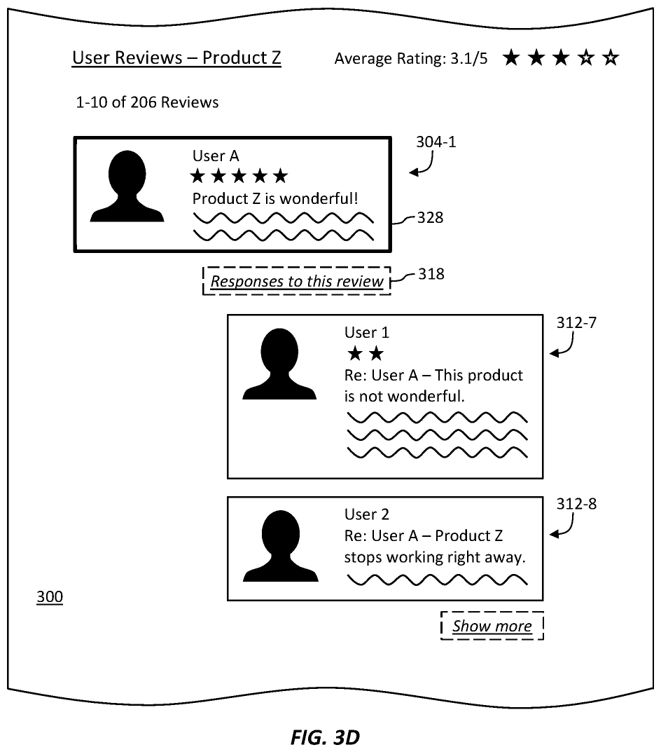

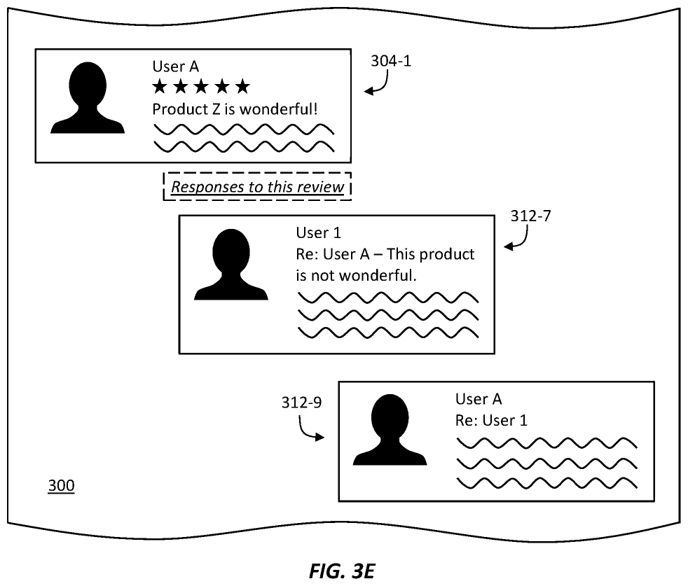

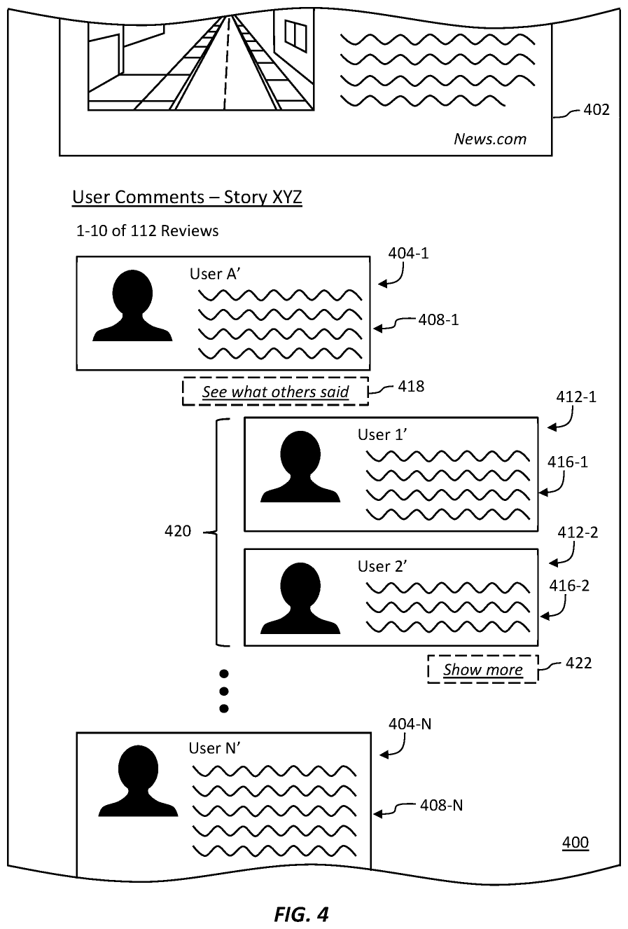

With reference to the system 100 in FIGS. 1 and 2, in response to the user request, the web server application 110 may retrieve, e.g., from the database(s) 102, one or more user-generated data items 122 for display on the webpages 300, 400, along with the requested web content. Each user-generated data item 122 may comprise one or more of a photo or representation 130 of the user who generated the user-generated data item 122 (i.e., the author), a user rating 132, and a textual portion 134 comprising a user review, comment, opinion, and the like. For example, as shown in FIGS. 3A-3E, the webpage 300 may be generated in response to a user request to view information related to a particular product, e.g., “Product Z,” and may include one or more user-generated data items 304-1 to 304-N associated with Product Z, where N is an integer, N≥1 (referred to herein collectively as user-generated data items 304). The user-generated data items 304 may be created or authored by one or more users, User A to User N. In the example shown in FIG. 4, the webpage 400 may be generated in response to a user request to view a particular news item, e.g., news article 402, and may include one or more user-generated data items 404-1 to 404-N associated with the news article 402, where N is an integer, N≥1 (referred to herein collectively as user-generated data items 404). The user-generated data items 404 may be created or authored by one or more users, User A′ to User N′.

In some examples, the user-generated data items 122 may have been provided directly from the Users A to N and A′ to N′ to the system 100, e.g., by visiting a website (not shown) provided by the system 100 and supplying a user rating, review, etc. In other examples, the system 100 may receive, e.g., from the other system(s) 100′ via the network 104, one or more user-generated data items, which may be added to the user-generated data items 122 stored in the database(s) 102. The system 100 may comprise, for example, a retailer, distributor, reseller, etc. and may exchange information with the system(s) 100′. Alternatively or in addition, the system 100 may monitor one or more websites (not shown) generated by the one or more other systems 100′ for user-generated data items to be added to the user-generated data items 122 stored in the database(s) 102. For example, the system 100 may employ a web crawler application (not shown) to collect and analyze information contained in the website(s) generated by the other system(s) 100′.

The application server 108 may comprise a review and selection application 112 that reviews the user-generated data items 122 and selects one or more for additional processing. The user-generated data item(s) 122 (also referred to herein as first user-generated data items or first user-generated content (UGC)) may be selected based at least in part on a content (also referred to herein as a first content) of the first UGCs 122. For example, with reference to FIGS. 3A-3C, the first content may comprise a user rating 306-1 to 306-N, where N is an integer, N≥1 (referred to herein collectively as user ratings 306). The user ratings 306 may be based on a numerical rating system (e.g., “4/5”) and/or a symbolic or graphical rating system (e.g., 4 stars). In the webpage 300 shown in FIGS. 3A and 3C, five stars is a maximum rating and one star is a minimum rating, and Product Z has an average rating 310, which may be represented numerically (i.e., “3.1/5”) and/or graphically (e.g., using stars). Alternatively or in addition, with reference to FIGS. 3A-3C and 4, the first content may comprise a textual content 308-1 to 308-N, 408-1 to 408-N, where N is an integer, N≥1 (referred to herein collectively as textual content 308 and 408, respectively), in which each textual content 308, 408 comprises, for example, a user review, comment, opinion, and the like.

In some examples, the review and selection application 112 may randomly select the one or more first UGCs. In some particular examples, the UGCs 122 may be grouped, based on the first content, into one or more groups (not shown) containing UGCs that all relate to a particular product, service, topic, or other common subject matter, and the review and selection application 112 may make a random selection of one or more UGCs from the group(s).

In other examples, review and selection of the one or more first UGCs may be based, at least in part, on a comparison of one or more portions of the first content with a predetermined metric. With reference to the user ratings 306 in FIGS. 3A-3C, reviewing the first UGCs 304 may comprise extracting the respective user rating 306 from each first UGC 304. In some examples, the predetermined metric may comprise the minimum and maximum rating of the respective rating system. For instance, the review and selection application 112 may compare the user ratings 306 to the minimum and maximum ratings of one and five stars, respectively, and may select one or more of the first UGCs 304 based on a level of polarity of the user ratings 306 with respect to the minimum and maximum ratings. Thus, first UGC 304-1 in FIG. 3A may be selected due, at least in part, to the fact that User A gave Product Z the maximum rating 306-1 of five stars, and/or first UGC 304-3 in FIG. 3C may be selected due, at least in part, to the fact that User D gave Product Z the minimum rating 306-3 of one star. In other examples, the predetermined metric may comprise the average rating 310. The review and selection application 112 may compare the user ratings 306 to the average rating 310, and when the user rating 306 is above or below the average rating 310 by a predetermined amount, then the first UGC 304 may be selected. For example, the predetermined amount may comprise at least one unit (i.e., one star) above or below the average rating 310. Thus, in the examples set out in FIGS. 3B and 3C, first UGCs 304 with user ratings 306 that are greater than or equal to 4.1 and/or less than or equal to 2.1 may be selected for processing.

With respect to the textual content 308, 408, reviewing the first UGCs 304, 404 may comprise conducting a sentiment analysis of the textual content 308, 408 in accordance with known methods to determine an overall tone or sentiment. For example, with reference to FIG. 3A, sentiment analysis of the textual content 308-1 and 308-2 (e.g., “Product Z is wonderful!” and “Love Product Z!”) of first UGCs 304-1 and 304-2 may indicate that they include a positive tone/sentiment, and the textual content 308-N (e.g., “Product is OK but could use improvement”) of first UGC 304-N may be categorized as including a neutral tone/sentiment. As shown in FIG. 3C, sentiment analysis of the textual content 308-3 (“Product Z is terrible!”) of first UGC 304-3 may indicate that it includes a negative tone/sentiment. Similarly, with reference to FIG. 4, sentiment analysis of the textual content 408 may indicate that first UGC 404-1 includes a positive tone/sentiment (e.g., User A′ expresses a favorable opinion of the news article 402, User A′ agrees with an opinion expressed in the news article 402, etc.) and that first UGC 404-N includes a negative tone/sentiment (e.g., User N′ expresses an unfavorable opinion of the news article 402, User N′ disagrees with an opinion expressed in the news article 402, etc.).

The review and selection application 112 may select one or more of the first UGCs 304, 404 based at least in part on the tone or sentiment expressed in the first UGCs 304, 404 (i.e., positive or negative). As part of the sentiment analysis, the textual content 308, 408 of each first UGC 304, 404 may be assigned a sentiment score (i.e., strongly positive, positive, neutral, negative, strongly negative), and the predetermined metric may comprise, for example, a level of polarity of the tone/sentiment. For instance, the sentiment score of the textual content 308-1 and 408-1 of first UGCs 304-1 and 404-1 may indicate that they include a strongly positive tone/sentiment, while the sentiment score of the textual content 308-3 of first UGC 304-3 may indicate that it includes a strongly negative tone/sentiment. One or more of these first UGCs 304-1, 304-3, 404-1 may be selected due, at least in part, to the fact that they contain a strongly positive or strongly negative tone/sentiment.

The system 100 may then review a plurality of related user-generated data items (also referred to herein as related UGCs); select one or more of the related UGCs; and automatically provide the one or more selected, related UGCs with the selected, first UGC. The system 100 may designate a UGC as being “related” to another UGC when, for example, an author or creator of the UGC designates it as being associated with a same product, service, news article, journal paper, etc. that is the subject of at least a portion of the first UGC; the related UGC contains at least one portion of content that is directed to a same product, service, article, journal paper, etc. as the first UGC, e.g., as determined based on keyword analysis or other known methods; and/or the author/creator provides the UGC in response to another UGC.

The related UGCs may comprise the UGCs 122 stored in the database(s) 102. Each related UGC comprises a content (also referred to herein as a second content). With reference to FIGS. 3B-3E and 4, the related UGCs may comprise UGCs 312-1 to 312-9 and 412-1 to 412-2 (referred to herein collectively as related UGCs 312 and 412, respectively), and the second content of each related UGC 312, 412 may comprise one or more of a user rating 314-1 to 314-6 (referred to herein collectively as user ratings 314) and a textual content 316-1 to 316-4 and 416-1 to 416-2 (referred to herein collectively as textual content 316 and 416, respectively), as described above in detail with respect to the first content. Each related UGC may comprise a unique second content, as compared to the first content of the first UGC 304, 404 and to the second content of the other related UGCs.

The review and selection application 112 may initially determine which of the UGCs 122 are “related” to the first UGC 304, 404. In particular, the review and selection application 112 may determine which of the UGCs 122 comprise second content with one or more portions that relate to one or more portions of the first content of the first UGC 304, 404. For example, for first UGCs 304-1 and 304-3 in FIGS. 3A and 3C, the related UGCs may comprise UGCs 312 that are directed to Product Z, and for first UGC 404-1 in FIG. 4, the related UGCs may comprise UGCs 412 related to news article 402. In some examples, the related UGCs may comprise one or more preexisting UGCs that were created (independently) at an earlier time and provided to the system 100. In other examples, the related UGCs may be retrieved from one or more different websites (not shown), e.g., via a web crawler as described above and added to the UGCs 122 for review and selection.

In further examples, the system 100 may generate one or more of the plurality of related UGCs based on the selected first UGC 304, 404 and/or based on one or more of the related UGCs 312, 412. With reference to FIGS. 2 and 3D, the application server 108 may comprise a request generator 114 that may transmit a request, e.g., via the network 104, to one or more users, e.g., Users 1 and 2, to provide a response to one or more portions of a particular one of the first UGCs, e.g., 304-1. These one or more users are users other than an author of the first UGC 304-1 and may be randomly selected (e.g., from a pool of verified purchasers, subscribers, etc.) or may have previously (independently) provided their own feedback regarding Product Z. The system 100 may then receive one or more responses from Users 1 and/or 2, and based on the response(s), the system 100 may generate one or more UGCs, e.g., 312-7, 312-8, which may include a user rating and/or textual content (not separately labeled) and may be included in the one or more related UGCs 312, 412 for selection. With reference to FIGS. 2 and 3E, the system 100 may generate one or more of the plurality of related UGCs 312, 412 based on one or more of the responses. For example, the request generator 114 may transmit a request to an author, e.g., User A, of the first UGC 304-1 to provide a reply to one or both of the related UGCs 312-7, 312-8. The system 100 may receive a reply from User A to related UGC 312-7 and may generate related UGC 312-9, which may include a user rating and/or textual content (not separately labeled) and may be included in the UGCs 122 for review and selection.

In one example scenario, with reference to FIGS. 3D and 3E, Product Z may comprise a computer, and User A may be using the computer to perform one or more first tasks that the computer handles well. User A gives the computer a high rating and a positive review in his or her UGC 304-1 but does not mention the first task(s). However, User 1 may be using the computer for one or more second, different tasks that the computer does not handle well, and User 1 may mention these different task(s) in his or her UGC 312-7. In the UGC 312-9 created by User A in response to User 1, User A may clarify that he or she was using the computer to perform the first task(s) and has never used the computer to perform the second task(s).

Following a determination of the related UGCs 312, 412, the system 100 may review the related UGCs 312, 412 and select one or more of the related UGCs 312, 412 based, at least in part, on the first content of the first UGC 304, 404 and the second content of the related UGC 312, 412. Reviewing the related UGCs 312, 412 may comprise extracting, by the review and selection application 112, the respective user rating 314 from each related UGC 312 and/or conducting a sentiment analysis of the textual content 316, 416 to determine an overall tone or sentiment, as described above with respect to the first UGCs 304, 404. Reviewing the related UGCs 312, 412 may also comprise determining whether any of the related UGCs 312, 412 comprise a response to a particular first UGC 304, 404 or a reply to a particular related UGC 312, 412.

In some examples, the review and selection application 112 may make a random selection of one or more of the related UGCs 312, 412. The random selection may include related UGCs 312 with similar and/or dissimilar user ratings 314 and/or related UGCs 312, 412 comprising textual content 316, 416 with a similar and/or dissimilar tone or sentiment. In other examples, the review and selection application 112 may select one or more of the related UGCs 312, 412 that comprise a response to a particular first UGC 304, 404 or a reply to a particular related UGC 312, 412. For example, when the first UGC 304-1 is selected, one or both of the related UGCs 312-7, 312-8 may be selected because they were generated specifically in response to the first UGC 304-1, and when the related UGC 312-7 is selected, the related UGC 312-9 may be selected because it was generated specifically in response to the related UGC 312-7.

In further examples, the review and selection application 112 may compare one or more portions of the first content of the selected first UGC, e.g., first UGC 304-1, 304-3, or 404-1 in FIGS. 3B, 3C, and 4, with the second content of one or more of the related UGCs 312, 412 and select one or more of the related UGCs 312, 412 based on the comparison. In one particular example, at least a portion of the second content of one or more of the selected, related UGCs 312, 412 may oppose or contradict at least a portion of the first content of the selected first UGC 304-1/304-3/404-1. For instance, the review and selection application 112 may compare the user ratings 306 to the user ratings 314 and select one or more of the related UGCs 312 based, at least in part, on a difference between the respective user ratings 306, 314. In some instances, the related UGCs 312 may be categorized as “contradicting/opposing” the selected first UGC 304-1/304-3/404-1 when a minimum difference between the respective user ratings 306, 314 is greater than or equal to one unit, i.e., at least one star. As shown in FIG. 3B, the review and selection application 112 may compare the user rating 306-1 (five stars) in first UGC 304-1 to the user ratings 314 in the related UGCs 312 and may select related UGCs 312-1 to 312-3 based, at least in part, on the fact that they contain user ratings 314-1 to 314-3 (one or two stars) that oppose, i.e., are lower than, the user rating 306-1. Similarly, as shown in FIG. 3C, the review and selection application 112 may perform a similar comparison for first UGC 304-3 and may select related UGCs 312-4 to 312-6 based, at least in part, on the fact that they contain user ratings 314-4 to 314-6 (four or five stars) that oppose, i.e., are higher than, the user rating 306-3 (one star).

Alternatively or in addition, the review and selection application 112 may compare the tone/sentiment in the selected first UGC 304-1/304-3/404-1 with a tone/sentiment in the related UGCs 312, 412 and select one or more of the related UGCs 312, 412 based on a difference between the respective tones/sentiments. For example, as shown in FIG. 3B, the review and selection application 112 may compare the tone/sentiment of first UGC 304-1, which contains textual content 308-1 with a positive tone/sentiment, to the tone/sentiment of the related user-generated data items 312 and may select related UGCs 312-1 and 312-2 based, at least in part, on the fact that their respective textual content 316-1 and 316-2 indicates an opposing, i.e., negative or strongly negative, tone/sentiment. As shown in FIG. 3C, the review and selection application 112 may similarly compare the tone/sentiment of first UGC 304-3, which contains textual content 308-3 with a negative tone/sentiment, to the tone/sentiment of the related UGCs 312 and may select related UGCs 312-4 and 312-5 based, at least in part, on the fact that their respective textual content 316-3 and 316-4 indicates an opposing, i.e., positive or strongly positive, tone/sentiment. Likewise, UGCs 412-1 and 412-2 in FIG. 4 may be selected based, at least in part, on the fact that their respective textual content 416-1 and 416-2 contains a negative tone/sentiment, which opposes the positive tone/sentiment in the textual content 408-1 associated with first UGC 404-1.

In another particular example, at least a portion of the second content of one or more of the selected, related UGCs 312, 412 may support or confirm at least a portion of the first content of the selected first UGC 304-1/304-3/404-1. The review and selection application 112 may make comparisons as described above and may select one or more of the related UGCs 312 based, at least in part, on a similarity between the user ratings 306 and/or the tone/sentiment of the selected first UGC 304-1/304-3/404-1 and the user ratings 314 and/or the tone/sentiment of the related UGCs 312, 412. For example, for first UGC 304-1 and related UGCs 312-4 to 312-6 may be selected based on the similarity of their respective user ratings 314-4 to 314-6 (four or five stars) to the user rating 306-1 (five stars) contained in the first UGC 304-1 and/or based on the similarity in the tone/sentiment (positive or strongly positive) of their respective textual contents 308-1, 316-3, 316-4. For first UGC 304-3, UGCs 312-1 to 312-3 may be selected based on the similarity of their respective user ratings 314-1 to 314-3 (one or two stars) to the user rating 306-3 (one star) contained in first UGC 304-3 and/or based on the similarity in the tone/sentiment (negative or strongly negative) of their respective textual contents 308-3, 316-1, 316-2. In some instances, the related UGCs 312 may be categorized as “supporting/confirming” the selected first UGC 304-1/304-3/404-1 when a maximum difference between the respective user ratings 306, 314 is less than or equal to one unit, i.e., at least one star.

In some implementations, following the comparison as described above, the review and selection application 112 may make a random selection of the related UGCs 312, 412 that comprise the second content that either contradicts or supports at least a portion of the first content of the selected one of the first UGCs 304-1/304-3/404-1. In other implementations, the review and selection application 112 may select one or more of the related user-generated data items 312, 412 based on a level of polarity of the second content with respect to the first content of the selected one of the first UGCs 304-1/304-3/404-1. For example, as shown in FIG. 3B, the UGC 304-1 includes user rating 306-1 with the maximum rating (five stars), and the review and selection application 112 may select at least one related UGC, e.g., 312-1 and/or 312-2, comprising user ratings 314-1 and 314-2 with the minimum rating (one star). Similarly, as shown in FIG. 3C, the UGC 304-3 includes user rating 306-3 with the minimum rating, and at least one of the selected, related UGCs, e.g., related UGCs 312-4 and 312-6, includes user ratings 314-4 and 314-5 with the maximum rating. The level of polarity may similarly be taken into consideration with respect to the tone/sentiment. For example, the textual content 308-1 associated with the first UGC 304-1 is strongly positive, and the review and selection application 112 may select at least one related UGCs, e.g., 312-1 and/or 312-2, comprising textual content 316-1 and 316-2 that is strongly negative, and vice versa.

In further implementations, one or more weights may be applied by a weighting application 116 (see FIG. 2) to the one or more related UGCs 312, 412 based on one or more of the user rating 314 and the tone/sentiment of the textual content 316, 416. In some examples, the weighting application 116 may apply a first weight to the one or more related UGCs 312, 412 containing the second content that opposes or supports the first content and may apply one or more additional weights to remaining ones of the related UGCs 312, 412, in which the first weight is greater than the one or more additional weights. In some instances, the weights may be applied based on a polarity of the user ratings 314 and/or the tone/sentiment of the textual content 316, 416, as compared to the user rating 306 and/or tone/sentiment of the textual content 308, 408 of the first UGC 304, 404. The review and selection application 112 may then use this weighting to select the one or more related UGCs 312, 412.

For example, with reference to FIG. 3B, the first UGC 304-1 includes a maximum user rating 306-1 of five stars, and the weighting application 116 may apply a highest weight to related UGCs, e.g., 312-1 and 312-2, with minimum user ratings 314-1 and 314-2 of one star, i.e. opposite to user rating 306-1. A next highest weight may be applied to related UGCs, e.g., 312-3, with a user rating 314-3 of two stars, and so on, with a lowest weight being applied to UGCs that contain a user rating (i.e., five stars) that is the same as the user rating 306-1. The review and selection application 112 may then select one or more of the related UGCs 312 based on their respective weights. In an exemplary scenario, the review and selection application 112 may select a set of the related UGCs 312 comprising 50% with the highest weight (i.e., the lowest user rating of one star) and 25% with the second highest weight (two stars), with the remaining 25% being divided between related UGCs 312 with user ratings of three and four stars. With reference to FIG. 3C, the weighting application 116 may similarly apply a highest weight to related UGCs, e.g., 312-4 and 312-5, with maximum user ratings 314-4 and 314-5 (five stars) that are opposite the user rating 306-3 (one star) and may apply decreasing weights to the related UGCs with four stars (e.g., 312-6), three stars, and so on. A set of the related UGCs 312 may then be selected based on their respective weights, as described above.

With reference to FIGS. 3B, 3C, and 4, alternatively or in addition, the weighting application 116 may apply weights to the related UGCs 312, 412 based on the tone/sentiment in the textual content 316, 416. With respect to the first UGC 304-1, related UGCs 312-1 and 312-2 may be given a highest weight, as they contain textual content 316-1 and 316-2 with a sentiment score indicating a strongly negative tone/sentiment, which is opposite to the strongly positive tone/sentiment of the textual content 308-1 of the first UGC 304-1. A second highest weight may be applied to related UGCs 312, 412 with a negative tone/sentiment, and so on, with a lowest weight being applied to related UGCs 312, 412 with a strongly positive tone/sentiment. Varying weights may similarly be applied to the related UGCs 312, 412 based on the tone/sentiment of the first UGCs 304-3 and 404-1. In each instance, a set of the related UGCs 312, 412 may then be selected based on their respective weight, as described above.

With reference to FIGS. 3A-3E and 4, following selection, the one or more related UGCs 312, 412 may be automatically provided along with the respective one of the first UGCs 304-1/304-3/404-1. In particular, the related UGCs 312, 412 may be automatically appended by the system 100 to the respective first UGC 304-1/304-3/404-1. In some examples, automatically appending the one or more related UGCs 312, 412 may comprise causing or driving the display, along with the respective first UGC 304-1/304-3/404-1, of a link 318, 418 to the related UGCs 312, 412 (e.g., “See what others said” or “Responses to this review”). For instance, a reader may click, select, or otherwise activate the link 318 in FIG. 3A to display the related UGCs 312-1 to 312-3, as shown in FIG. 3B. In other examples, automatically appending the one or more related UGCs 312, 412 may comprise causing or driving the display, along with the respective first UGC 304-1/304-3/404-1, of a thread 320-1, 320-2, 420 comprising the respective related UGCs 312, 412. In all examples, only a portion of the related UGCs 312, 412 may be displayed, and a second link 322, 422 (“Show more”) may be displayed to allow the user to view additional related UGCs 312, 412. In instances in which one or more of related UGCs 312-7 to 312-9 comprise a response to a particular one of the first UGCs 304, 404 and/or a reply to another related UGC 312, 412, these one or more related UGCs 312-7 to 312-9 may be automatically appended to their respective first UGC(s) 304, 404 and/or related UGCs 312, 412, as shown in FIGS. 3D and 3E.

Providing the one or more related UGCs 312, 412 gives the reader a context for the first UGC 304, 404 and may allow the reader to evaluate the authenticity and truthfulness of the first UGCs 304, 404. For example, a consumer who is considering whether to purchase Product Z may review one or more of the UGCs 304 to assist in making the purchasing decision. However, at least some of the UGCs 304 may have been provided by, for example, paid users who are less likely to provide an objective rating or review of Product Z. In other examples, some of the UGCs 304 may have been provided by the manufacturer of Product Z, who may be motivated to provide an artificially high rating and/or strongly positive review, or by a competitor, who may be motivated to provide an artificially low rating and/or strongly negative review. In all cases, the consumer may be misled and may choose to buy (or refrain from buying) Product Z based on false information.

The consumer may consider the related UGCs 312 to help determine which of the UGCs 304 are likely genuine, such that the consumer is able to make a more objective and well-informed purchasing decision. For example, if the majority of the related UGCs 312 contain low ratings of Product Z and/or reviews with a negative tone/sentiment, the consumer may choose to disregard the UGC 304-1, which contains a high rating and a very positive review. Likewise, if the majority of the related UGCs 312 contain high ratings of Product Z and/or reviews with a positive tone/sentiment, the consumer may choose to disregard the UGC 304-3, which contains a low rating and a very negative review. Related UGCs, e.g., 312-7 and 312-8 in FIG. 3D, that are generated specifically in response to first UGC 304-1 may be particularly helpful in assessing the authenticity and truthfulness of the first UGC 304-1, as it contains the highest rating and a strongly positive review and may potentially be fraudulent or biased. The additional clarification and explanation from User A in UGC 312-9 in FIG. 3E may help to assure the reader that the first UGC 304-1 is genuine and may further help the reader in making a purchasing decision.

Similarly, a reader who is reading the news article 402 may review one or more of the UGCs 404 to determine a prevailing sentiment (i.e., positive/agreement or negative/disagreement) among other readers regarding, for example, a topic or event discussed in the news article 402, an author of the news article 402, the webpage 400 that provided the news article 402, etc. Users who are paid or may otherwise be motivated to provide a biased review may provide a distorted picture of the prevailing sentiment, which may mislead the reader. Providing one or more related UGCs 412 may help the reader to determine which of the UGCs 404 are likely genuine, such that the reader will be able to more accurately determine the prevailing sentiment.

In some examples, one or more sections of the first content of the first UGCs 304, 404 may be flagged by the system 100 based on the second content of one or more of the related UGCs 312, 412. With reference to FIG. 3B, one or more sections 324 of the textual content 308-1 in the first UGC 304-1 may be flagged based on the second content of at least one of the selected, related UGCs, e.g., related UGCs 312-1 and 312-2. The one or more section(s) 324 may be flagged to indicate agreement or disagreement on one or more points between Users A, 1, and 2. For instance, the textual content 308-1 of the first UGC 304-1 may contain a statement that “Product Z is very durable,” while the textual content 316-1, 316-2 of related UGCs 312-1 and 312-2 may state, for example, that “Product Z is not durable” or “Product Z breaks quickly.” Thus, the section 324 flagged in the first UGC 304-1 may include the statements regarding the durability of Product Z, as this is one point on which Users A, 1, and 2 disagree. Alternatively or in addition, Users 1 and 2 may agree with User A on one or more points (e.g., Product Z′s packaging is poorly designed, Product Z is environmentally friendly, etc.) and the one or more sections 324 related to this point of agreement may be flagged.

In all instances, the one or more corresponding sections 326-1 and 326-2 of the respective textual content 316-1, 316-2 of related UGCs 312-1, 312-2 may optionally be flagged in a similar manner to emphasize these sections 326-1, 326-2 and draw the reader's attention to these points of agreement or disagreement. One or more sections (not separately labeled) of the respective textual content 308-3, 316-3, 316-4 of the first UGC 304-3 and related UGCs 312-4, 312-5 in FIG. 3C and one or more sections (not shown) of the respective textual content 408-1, 416-1, 416-2 of the first UGC 404-1 and related UGCs 412-1, 412-2 in FIG. 4 may similarly be flagged, e.g., to indicate agreement or disagreement on one or more points. Flagging the section(s) 324, 326-1, 326-2 may comprise highlighting, outlining, bolding/italicizing, increasing a font size, and/or one or more other suitable techniques for emphasizing the section(s) 324. Different emphasis may be used to indicate points of disagreement vs. points of agreement between Users A, 1, and 2. In all instances, when one or more sections of the first UGC 304, 404 are flagged, the first UGC 304, 404 may further comprise an indication (not shown) providing one or more of statistics or data related to flagging of the sections to help the reader gauge why the one or more sections are flagged. For example, the statistics/data may show how many of the respective related UGCs 312, 412 contain corresponding section(s) that agree with the point(s) discussed in the flagged sections of the first UGC 304, 404; disagree with the point(s); and/or contain no mention of the point(s). In other examples, the statistics/data may show how many users used the product, service, etc. for a particular purpose and faced a same issue discussed in the first UGC 304, 404; how many users did not use the product, service, etc. for the particular purpose or did not face the same issue when using the product, service, etc. this way; or some other statistics/data that actually helped flag the point. This indication may help the reader to gauge the importance of the point(s) discussed in the flagged sections of the first UGC 304, 404. For example, if only a few users are discussing a particular point, the reader may choose to ignore this flagged section.

The system 100 may further be used to automatically detect fraudulent UGCs. Some users, such as paid contributors, may use a template to post multiple UGCs on the same website and/or across multiple different websites. These UGCs may also include poor grammar, unusual or inappropriate words, and/or other indications that they are not genuine. With reference to FIGS. 1 and 2, as part of the process of reviewing the UGCs 304, 312, 404, 412, the review and selection application 112 may utilize keyword matching and/or phrase matching to compare the textual content 308, 316, 408, 416 of the UGCs 304, 312, 404, 412 to one or more keywords and/or phrases 124 stored in the database(s) 102. When there is a match between one or more of the keywords and/or phrases 124 and the textual content 308, 316, 408, 416, the system 100 may flag the UGCs 304, 312, 404, 412. For example, with reference to FIG. 3D, comparison of the first UGC 304-1 to the keywords/phrases 124 may result in a match, e.g., the first UGC 304-1 uses certain words or phrases commonly associated with fraudulent UGCs or may be based on a template known to be used in fraudulent UGCs. The system 100 may generate an alert related to the first UGC 304-1, which may indicate that the first UGC 304-1 is potentially fraudulent. The system 100 may also alter an appearance of the first UGC 304-1 on the webpage 300, e.g., by an outline 328 that is heavier or a different color, as compared to the outlines of other UGCs and/or by text (e.g., “Suspected fraudulent review”; not shown), to notify readers that the first UGC 304-1 is potentially fraudulent.

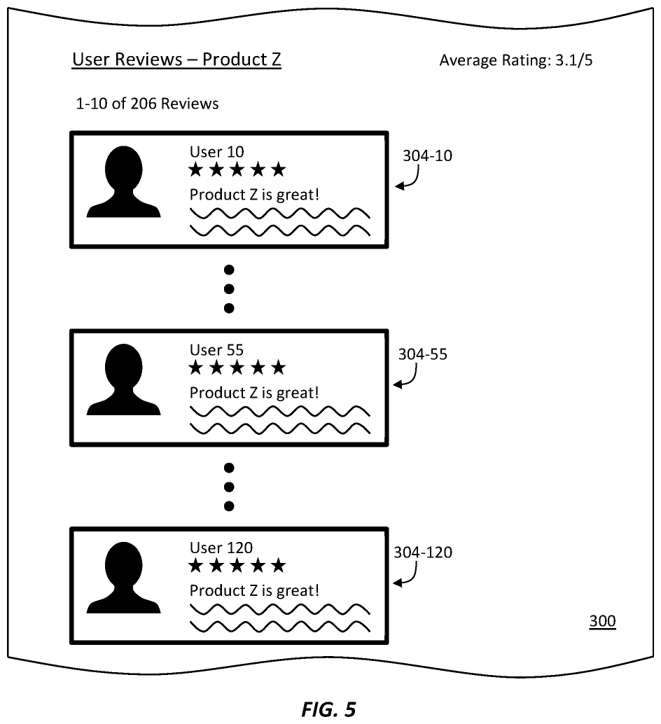

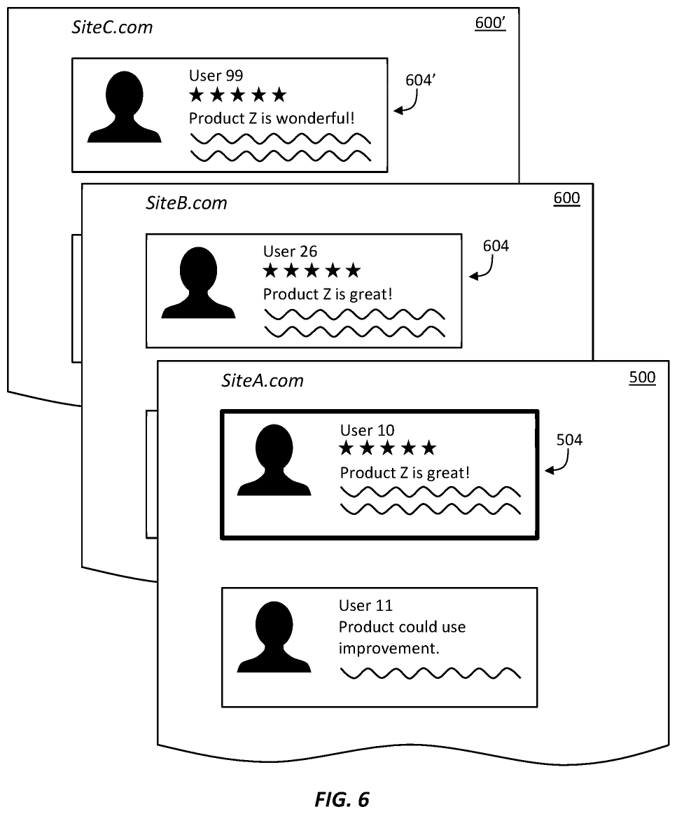

The system 100 may also compare the UGCs 304, 312, 404, 412 to each other to detect a match. For example, as shown in FIG. 5, the review and selection application 112 may compare the textual content (not separately labeled) of UGC 304-10 to the textual content of UGCs 304, 312 and may determine that at least a portion of the textual content of the UGC 304-10 matches the textual content of one or more other UGCs, e.g., UGCs 304-55 and 304-120, on the same webpage 300. As shown in FIG. 6, the system 100 may also detect that a UGC with the same or substantially similar textual content is provided across multiple websites. The system 100 may generate a webpage 500, and as described above, the system 100 may employ a web crawler application (not shown) to collect and analyze UGCs contained in one or more other websites 600, 600′. The review and selection application 112 may compare the textual content (not separately labeled) of a UGC 504 on the webpage 500 to the UGCs found on the websites 600, 600′ and may determine that at least a portion of the textual content of the UGC 504 matches the textual content (not separately labeled) of UGCs 604 and 604′ on the websites 600, 600′, respectively. Users 10, 26, 55, 99, and/or 120 in FIGS. 4 and 5 may all be the same user who has used established multiple accounts or may be one or more users who are paid to create UGCs based, for example, on a template. In all cases, the system 100 may generate an alert related to one or more of the UGCs 304-10, 304-55, 304-120, 504 and may alter their appearance on the webpage 300, 500, as described above.

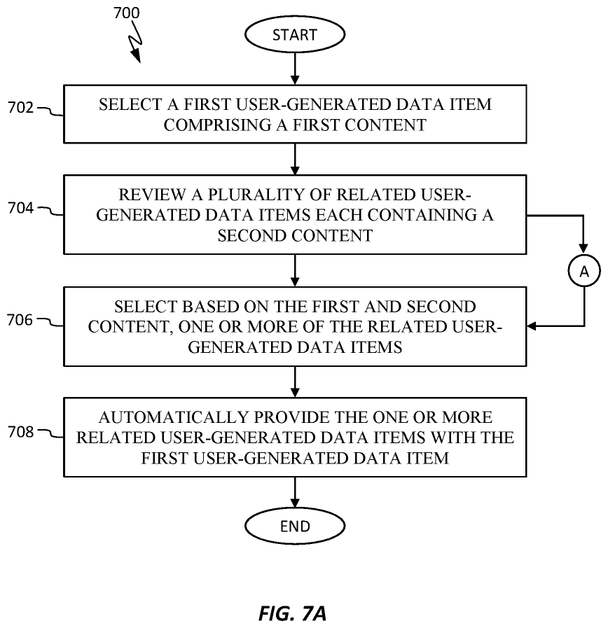

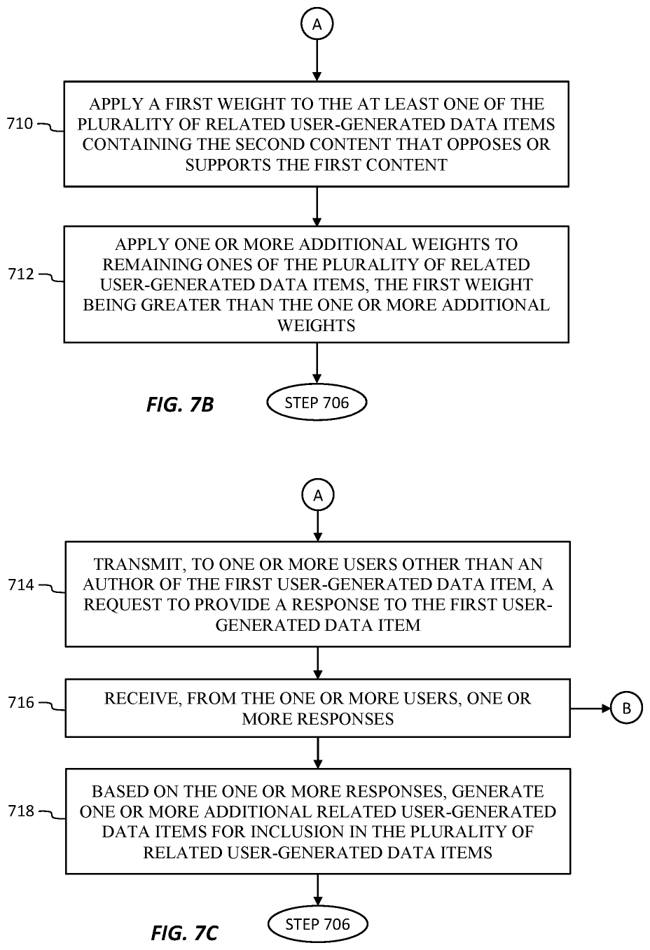

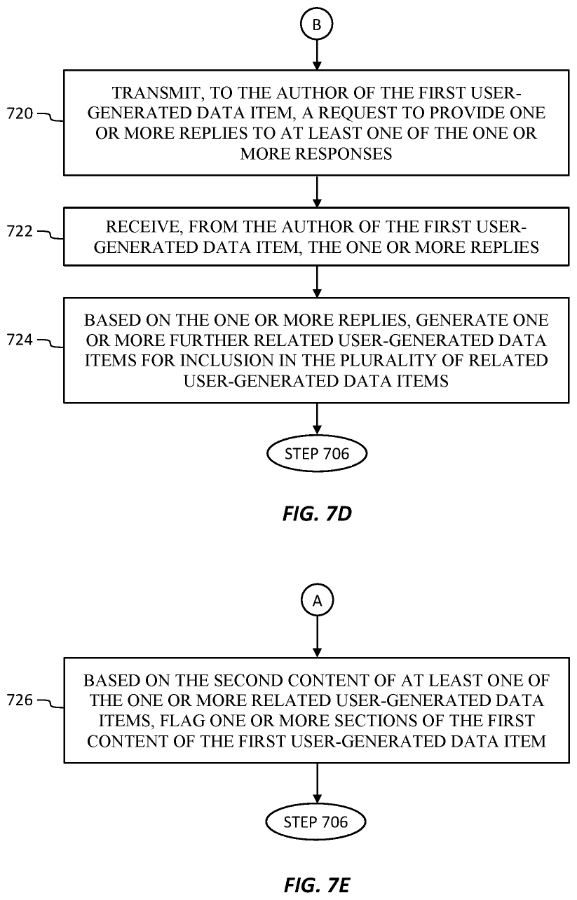

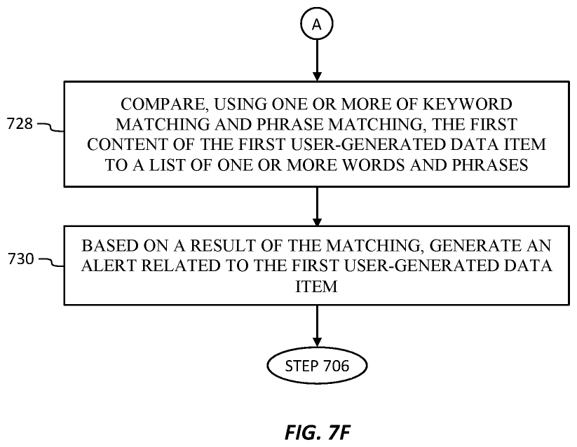

FIGS. 7A-7F illustrate exemplary methods in accordance with the present disclosure. The methods set out in FIGS. 7A-7F may be performed all or in part by a processor of a system, e.g., by the processor 136 of the application server 108 of FIG. 2, that is in communication with a memory device, e.g., the memory 126, database(s) 102, and/or other computer-readable storage medium, and executes instructions stored in the memory device.

With reference to FIG. 7A, a method 700 for processing user-generated data items begins at Step 702 in which a first user-generated data item comprising a first content may be selected. At Step 704, a plurality of related user-generated data items each containing a second content may be reviewed, in which one or more portions of the second content of each related user-generated data item relate to one or more portions of the first content of the first user-generated data item. At Step 706, one or more of the related user-generated data items may be selected based on the first and second content, and the one or more related user-generated data items may be automatically provided with the first user-generated data item at Step 708, after which the method 700 may conclude.

In some examples, automatically providing the one or more related user-generated data items with the first user-generated data item may comprise automatically appending the one or more related user-generated data items to the first user-generated data item and driving a display, with the first user-generated data item, of at least one of a link to the one or more related user-generated data items or a thread comprising the one or more related user-generated data items. In some instances, the first content may comprise one or more of a first rating and a first review and the second content may comprise one or more of a second rating and a second review. In other instances, the first content may comprise one of a minimum rating or a maximum rating, and the second content of at least one of the selected user-generated data items may comprise the other of the minimum rating or the maximum rating.

FIGS. 7B-7F illustrate additional optional functions that may be performed. Although Steps 710 to 730 are depicted in FIGS. 7B-7F as occurring between Steps 704 and 706, it is understood that these Steps may occur at any point.

In some exemplary implementations, wherein at least one of the one or more portions of the second content of at least one of the related user-generated data items either opposes or supports at least one of the one or more portions of the first content of the first user-generated data item, and as shown in FIG. 7B, in some particular implementations in which a plurality of the related user-generated data items are selected, the method 700 of FIG. 7A may optionally comprise applying a first weight to the at least one of the plurality of related user-generated data items containing the second content that opposes or supports the first content in Step 710 and applying one or more additional weights to remaining ones of the plurality of related user-generated data items, the first weight being greater than the one or more additional weights in Step 712. The first weight and the one or more additional weights may be used in selecting the one or more related user-generated data items (Step 706 in FIG. 7A).

In other exemplary implementations as shown in FIG. 7C, the method 700 of FIG. 7A may optionally comprise generating one or more of the plurality of related user-generated data items by transmitting, to one or more users other than an author of the first user-generated data item, a request to provide a response to the first user-generated data item at Step 714; receiving, from the one or more users, one or more responses at Step 716; and based on the one or more responses, generating, one or more additional related user-generated data items for inclusion in the plurality of related user-generated data items at Step 718 (e.g., for use in Step 706). In addition, as shown in FIG. 7D, a request to provide one or more replies to at least one of the one or more responses may be transmitted to the author of the first user-generated data item at Step 720; one or more replies may be received from the author of the first user-generated data item at Step 722; and based on the one or more replies, one or more further related user-generated data items may be generated at Step 724 for inclusion in the plurality of related user-generated data items (e.g., for use in Step 706).

In additional exemplary implementations as shown in FIG. 7E, the method 700 of FIG. 7A may optionally comprise flagging, based on the second content of at least one of the one or more related user-generated data items, one or more sections of the first content of the first user-generated data item at Step 726.

In further exemplary implementations as shown in FIG. 7F, the method 700 of FIG. 7A may optionally comprise comparing, using one or more of keyword matching and phrase matching, the first content of the first user-generated data item to a list of one or more words and phrases at Step 728 and based on a result of the matching, generating an alert related to the first user-generated data item at Step 730.

The flowchart(s) and block diagram(s) in the Figures illustrate the architecture, functionality, and operation of possible implementations of systems, methods and computer program products according to various aspects of the present disclosure. In this regard, each block in the flowchart(s) or block diagram(s) may represent a module, segment, or portion of code, which comprises one or more executable instructions for implementing the specified logical function(s). In addition, while the flowcharts have been discussed and illustrated in relation to a particular sequence of events, it should be appreciated that changes, additions, and omissions to this sequence may occur without materially affecting the operation of the disclosure. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or by combining software and hardware implementation that may all generally be referred to herein as a “circuit,” “module,” “component,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may include, but is not limited to, an electronic, magnetic, optical, electromagnetic, or semiconductor system, apparatus, or device, or any suitable combination thereof. More specific examples may include an electrical connection having one or more wires; a floppy disk; a flexible disk; a hard disk; magnetic tape or any other magnetic medium; a magneto-optical medium; a random access memory (RAM); a read-only memory (ROM); an erasable programmable read-only memory (EPROM or Flash memory); a solid state medium like a memory card, chip, or cartridge; a portable compact disc read-only memory (CD-ROM); an optical storage device; an optical fiber; or any suitable combination thereof. A digital file attachment to email or other self-contained information archive or set of archives may be considered a distribution medium equivalent to a tangible storage medium. When the computer-readable media is configured as a database, it is to be understood that the database may be any type of database, such as relational, hierarchical, object-oriented, and/or the like. In the context of this document, a computer-readable storage medium may be any tangible storage medium or distribution medium and prior art-recognized equivalents and successor media that may contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that may communicate, propagate, or transport a program for use by or in connection with an instruction execution system, apparatus, or device. Program code embodied on a computer-readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as JAVA, SCALA, SMALLTALK, EIFFEL, JADE, EMERALD, C++, CII, VB.NET, PYTHON or the like, conventional procedural programming languages, such as the “c” programming language, VISUAL BASIC, FORTRAN 2003, PERL, COBOL 2002, PHP, ABAP, dynamic programming languages such as PYTHON, RUBY, and GROOVY, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks. Alternatively, a symmetric multiprocessor (SMP) system or other configuration including a plurality of processors may be used.

These computer program instructions may also be stored in a computer-readable medium that when executed may direct a computer, other programmable data processing apparatus, or other devices to function in a particular manner, such that the instructions when stored in the computer-readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions that execute on the computer or other programmable apparatus provide processes for implementing the functions/acts specified in the flowchart and/or block diagram block or blocks.

While the exemplary embodiments illustrated herein show the various components of the system collocated, certain components of the system may be located remotely, at distant portions of a distributed network, such as a LAN and/or the Internet, or within a dedicated system. Thus, it should be appreciated, that the components of the system may be combined into one or more devices, such as a switch, server, and/or adjunct, or collocated on a particular node of a distributed network, such as an analog and/or digital telecommunications network, a packet-switch network, or a circuit-switched network. It will be appreciated from the preceding description, and for reasons of computational efficiency, that the components of the system may be arranged at any location within a distributed network of components without affecting the operation of the system.

Furthermore, it should be appreciated that the various links connecting the elements may be wired or wireless links, or any combination thereof, or any other known or later developed element(s) that is capable of supplying and/or communicating data to and from the connected elements. These wired or wireless links may also be secure links and may be capable of communicating encrypted information. Transmission media used as links, for example, may be any suitable carrier for electrical signals, including coaxial cables, copper wire, and fiber optics, and may take the form of acoustic or light waves, such as those generated during radio-wave and infra-red data communications.

A number of variations and modifications of the disclosure may be used. It would be possible to provide for some features of the disclosure without providing others. For example, in one alternative embodiment, the systems and methods of this disclosure may be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein may be used to implement the various aspects of this disclosure. Exemplary hardware that may be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing may also be constructed to implement the methods described herein.

While the foregoing is directed to embodiments of the present disclosure, other and further embodiments of the present disclosure may be devised without departing from the basic scope thereof. It is understood that various embodiments described herein may be utilized in combination with any other embodiment described, without departing from the scope contained herein. Further, the foregoing description is not intended to be exhaustive or to limit the present disclosure to the precise form disclosed. Modifications and variations are possible in light of the above teachings or may be acquired from practice of the present disclosure.

What is claimed is:

1. A method comprising:
selecting, by a processor, a first user-generated data item comprising a first content;
reviewing, by the processor, a plurality of related user-generated data items each containing a second content, wherein one or more portions of the second content of each related user-generated data item relate to one or more portions of the first content of the first user-generated data item;
selecting, by the processor, based on the first and second content, one or more of the related user-generated data items; and
automatically providing, by the processor, the one or more related user-generated data items with the first user-generated data item.

2. The method of claim 1, wherein automatically providing the one or more related user-generated data items with the first user-generated data item comprises:
automatically appending the one or more related user-generated data items to the first user-generated data item; and
driving a display, with the first user-generated data item, of at least one of a link to the one or more related user-generated data items or a thread comprising the one or more related user-generated data items.

3. The method of claim 1, wherein:
the first content comprises one or more of a first rating and a first review; and
the second content comprises one or more of a second rating and a second review.

4. The method of claim 1, wherein:
the first content comprises one of a minimum rating or a maximum rating; and
the second content of at least one of the selected user-generated data items comprises the other of the minimum rating or the maximum rating.

5. The method of claim 1, wherein at least one of the one or more portions of the second content of at least one of the related user-generated data items either opposes or supports at least one of the one or more portions of the first content of the first user-generated data item.

6. The method of claim 5, wherein a plurality of the related user-generated data items are selected, the method further comprising:
applying, by the processor, a first weight to the at least one of the plurality of related user-generated data items containing the second content that opposes or supports the first content; and
applying, by the processor, one or more additional weights to remaining ones of the plurality of related user-generated data items, the first weight being greater than the one or more additional weights;
wherein the first weight and the one or more additional weights are used in selecting the one or more related user-generated data items.

7. The method of claim 1, further comprising:
generating, by the processor, one or more of the plurality of related user-generated data items by:
transmitting, by the processor, to one or more users other than an author of the first user-generated data item, a request to provide a response to the first user-generated data item;
receiving, by the processor, from the one or more users, one or more responses; and
based on the one or more responses, generating, by the processor, one or more additional related user-generated data items for inclusion in the plurality of related user-generated data items.

8. The method of claim 7, further comprising:
generating, by the processor, one or more of the plurality of related user-generated data items by:
transmitting, by the processor, to the author of the first user-generated data item, a request to provide one or more replies to at least one of the one or more responses;
receiving, by the processor, from the author of the first user-generated data item, the one or more replies; and
based on the one or more replies, generating, by the processor, one or more further related user-generated data items for inclusion in the plurality of related user-generated data items.

9. The method of claim 1, further comprising:
based on the second content of at least one of the one or more related user-generated data items, flagging, by the processor, one or more sections of the first content of the first user-generated data item.

10. The method of claim 1, further comprising:
comparing, by the processor, using one or more of keyword matching and phrase matching, the first content of the first user-generated data item to a list of one or more words and phrases; and
based on a result of the matching, generating, by the processor, an alert related to the first user-generated data item.

11. A system comprising:
a memory device, storing executable instructions;
a processor in communication with the memory device, wherein the processor when executing the executable instructions:
selects a first user-generated data item comprising a first content;
reviews a plurality of related user-generated data items each containing a second content, wherein one or more portions of the second content of each related user-generated data item relate to one or more portions of the first content of the first user-generated data item;
selects, based on the first and second content, one or more of the related user-generated data items; and
automatically provides the one or more related user-generated data items with the first user-generated data item.

12. The system of claim 11, wherein automatically providing the one or more related user-generated data items with the first user-generated data item comprises:
automatically appending the one or more related user-generated data items to the first user-generated data item; and
driving a display, with the first user-generated data item, of at least one of a link to the one or more related user-generated data items or a thread comprising the one or more related user-generated data items.

13. The system of claim 10, wherein:
the first content comprises one or more of a first rating and a first review; and
the second content comprises one or more of a second rating and a second review.

14. The system of claim 10, wherein:
the first content comprises one of a minimum rating or a maximum rating;
the second content of at least one of the selected user-generated data items comprises the other of the minimum rating or the maximum rating.

15. The system of claim 10, wherein at least one of the one or more portions of the second content of at least one of the related user-generated data items either opposes or supports at least one of the one or more portions of the first content of the first user-generated data item.

16. The system of claim 15, wherein a plurality of the related user-generated data items are selected and wherein the processor when executing the executable instructions further:
applies a first weight to the at least one of the plurality of related user-generated data items containing the second content that opposes or supports the first content; and
applies one or more additional weights to remaining ones of the plurality of related user-generated data items, the first weight being greater than the one or more additional weights;
wherein the first weight and the one or more additional weights are used in selecting the one or more related user-generated data items.

17. The system of claim 10, wherein the processor when executing the executable instructions further:
generates one or more of the plurality of related user-generated data items by:
transmitting, to one or more users other than an author of the first user-generated data item, a request to provide a response to the first user-generated data item;
receiving, from the one or more users, one or more responses; and
based on the one or more responses, generating one or more additional related user-generated data items for inclusion in the plurality of related user-generated data items.

18. The system of claim 17, wherein the processor when executing the executable instructions further:
generates one or more of the plurality of related user-generated data items by:
transmitting, to the author of the first user-generated data item, a request to provide one or more replies to at least one of the one or more responses;
receiving, from the author of the first user-generated data item, the one or more replies; and
based on the one or more replies, generating one or more further related user-generated data items for inclusion in the plurality of related user-generated data items.

19. The system of claim 10, wherein the processor when executing the executable instructions further:
based on the second content of the one or more related user-generated data items, flags one or more sections of the first content of the first user-generated data item.

20. The system of claim 10, wherein the processor when executing the executable instructions further:
compares, using one or more of keyword matching and phrase matching, the first content of the first user-generated data item to a list of one or more words and phrases; and
based on a result of the matching, generates an alert related to the first user-generated data item.
